(19) United States
(12) Patent Application Publication
(10) Pub. No.: US 2011/0019863 A1
(43) Pub. Date: Jan. 27, 2011

(54) Microphone-Shaped Speaker

(75) Inventor: John Gerard Kearns, Smithtown, NY (US)

Correspondence Address: PRYOR CASHMAN, LLP, 7 Times Square, NEW YORK, NY, 10036-6569, US

(73) Assignee: Rubie's Costume Co., Inc., Richmond Hill, NY (US)

(21) Appl. No.: 12/509,204

(22) Filed: Jul. 24, 2009

(51) Int. Cl. H04R 1/02

(52) U.S. Cl. 381/394; 381/386

(57) ABSTRACT

A microphone-shaped speaker device preferably for use by children, teenagers, young adults and even adults for leisure and fun. The microphone shaped device can be electrically connected and appear to be a regular microphone for receipt of lyrics of a song or a voice for playing through and out of a speaker but, in fact, it necessarily is also an audio speaker, located at or adjacent to the mouth of the entertainer. The device is connected to a source of audio, digital or analog, signals of the voices of pre-recorded entertainers. In this manner, an extremely realistic effect/illusion is provided, the user seems to be singing (when suitably lip synched to the lyrics of the pre-recorded songs), with the voice, tone, harmony, melody, etc. of the professional singer. When the microphone-shaped speaker device (a speaker contained at the head of the handle of an otherwise conventionally looking microphone) is selectively connected to a source of lyrics, normally with music such as an i-pod® or mp3-player and it transmits sound and the user lip-synchs to the lyrics, the transmitted sound, e.g. the voice of a famous pop music singer, provides the seemingly astounding, realistic and beguiling effect of having the same sound of the professional since the sound provided by the music and professional voice provider emanates to the audience from a point proximal the local singer's mouth, at least when the device is held as if it is a conventional microphone.

### BACKGROUND OF THE INVENTION

The present invention relates to a microphone-shaped and hand-holdable, speaker-like device. Preferably, the device is powered by self-contained batteries but it can be provided with an ac-adapter and powered by being plugged into conventional electrical power. In contrast to an actual microphone which receives audible sound from a speaker's mouth which is then directed as electrical signals to an amplifier and then to a speaker, where the sounds are emitted for others to hear, the invention does not first receive and then transmit sound to an audio output device but, quite unconventionally and inventively, it is a sound emitting speaker, hand-held and yet in the shape, for camouflage purposes, of a microphone. The device actually receives pre-recorded sounds and emits them just as an actual speaker does, i.e., for an audience to hear. By holding the device near one's mouth and having it appear to an audience that it is being used like a microphone the user visually appears as the source of the vocal sounds, effectively disguising the true source of the sound. In this manner, the device allows a user to lip-sync to a set of pre-recorded sounds such as the voice of a professional rock star or opera star, and, to the listeners of the sound produced by the speaker, it appears that the voice is substantially the same as that of the real and professional performer yet an amateur or friend standing right there in front of the audience. Since the user may connect the device either to a computer, a portable mp3-player, an i-pod® device, etc. (having one or more pre-recorded songs, with or without accompanying music) or in an alternative embodiment of the device, the electronics of an mp3-player (with recorded digital or analog signals for a voice) are contained within the handle of the device, playing the same and having the sound emanate from the speaker, visually appearing as a microphone for conventionally receiving the sound of a singer, a terrific illusion is created. It is not visually nor audibly obvious to the audience that the user is merely lip-syncing as he/she appears as the originator of the words, the lyrics, the sound, when in fact the pre-recorded sounds are coming directly from a speaker, located immediately adjacent to the mouth of the performer as the speaker of the device is held there. Since the device visually looks to the audience as a microphone the illusion is very effective.

### Description of the Prior Art

Virtually everybody in some stage of childhood or adolescence (and even many adults) has deliberately exhibited imitative vocal behavior. Sometimes we attempt to imitate a favorite song or professional performer. Sometimes we mouth the words or sing along to pre-recorded songs. We often try to do so in a miming manner and with the attitude and antics of various role models or of professional performers. Imitating figures from popular culture such as pop singers, opera singers, traditional balladeers, etc. sometimes with music and sometimes accompanied by dancing. The local performer, i.e., the one seeking to create the impression to another that he or she is the actual singing professional, tries to convince the audience, whether a friend, a lover, a family member, or a whole audience that he/she is actually singing and providing the vice. The effect is to make it appear that the vocal sounds of the pre-recorded professional singer (emanating from a radio; an i-pod®; an MP-3 player, a computer; etc. (hereinafter collectively often referred to as “pre-recorded professional singing” or “pre-recorded songs”) are identically reproduced by the local (and amateur) performer. These lip-synching performances are considered great fun and entertainment. They are often done in homes, in rec-rooms, basements, bedrooms, at parties and in clubs. The effect sought is usually the same, namely, the local performer, an amateur (usually without great talent) seeks to convince the audience (one or more listeners) that he/she actually has a great voice and knows the words of the song and that he/she can sing with substantially the same voice as the pre-recorded professional. The present invention enhances the performance and the illusion.

To further this objective, the present invention provides a microphone-shaped speaker device which has, as an input, one or more pre-recorded songs which is(are) played and transmitted out to the audience preferably through the head of the microphone-shaped, speaker device. This significantly enhances the lip-synching effect and, indeed, can be disarming as the sound is so closely associated with the mouth of the local performer that it often can not be determined whether the local performer does have the ability to exactly mime the pre-recorded professional song or is lip-synching the same. The ability to have the voice of the pre-recorded song and that recording professional emanate immediately adjacent the mouth of the local performer, by using a device which visually is not thought of as a speaker but rather is a normal voice pick-up device, enhances the entire performance and illusion by the local performer, normally an amateur.

A microphone has often been used for lip synching. The microphone receives the local singer's voice and transmits corresponding electrical signal to an amplifier and then the signal is caused to emanate from a remote (at least with respect to the mouth of the local performer) speaker. There the sound is heard by the audience, throughout the room. In most karaoke situations, the audio singing-sound heard by the audience is either the actual voice of the local performer (the amateur) or the actual voice of the recorded professional, if the local performer, the amateur, lip synchs to the words. In either case, however, it should be appreciated that the voice comes from a remote speaker. The overall visual effect, i.e., the realism of the karaoke experience is thus somewhat negatively affected by the sound coming from a remote speaker, not directly from the mouth of the local performer.

Thus, it should be readily apparent that the present invention, a microphone-shaped speaker, when held to the mouth of the local performer, enhances the impression that the local performer has the same voice and knows the lyrics and intonation of the professional, recording star. Using the present invention allows the local performer to much more realistically seem to be singing in the exact voice as that of the pre-recorded singing star.

Lip synching or imitative/karaoke singing as the professional singer performs his or her performance is a common activity and considered fun. It is frequently a source of overall entertainment at parties and bars. Young boys and girls enjoy lip synching with their friends, especially to their new and old favorite songs of pop music stars. There are various ways of doing so, from common singing along with the professional performances transmitted over the radio, to doing so in a karaoke context, to lip-syncing in front of an audience of family and friends. However all these activities have the relative flaw of either the non-professional or youth (sometimes adults) having to sing in his or her own voice and thereby not precisely imitating the sounds of the voice of the professional or the lip-synching, while visually effective, is a “little off” because the pre-recorded voice of the professional is perceived as not emanating from the mouth of the imitator. It is obviously a pre-recorded voice that is originating from some remote-located audio equipment. Lip-syncing with regular audio equipment (speakers located remotely, even on the floor adjacent to the lip-synching individual, cannot disguise the fact that the apparent singer is only miming a recording or voice, since the origin of the sounds is audibly and visually not the mouth of the local singer.

The present invention, due to it's ability to be connected to a portable mp3-player, i-pod®, computer, etc. especially if the electronics of the mp3-player or other digital or analog sound player of the pre-recorded songs are contained in the handle of the device, allows an amateur (or even a professional seeking to lip synch to his/her own voice, because of acoustics, laryngitis, or other reasons) to successfully appear as the live producer of the voice, the sounds, the song—as the actual and then original/current singer of the song. That illusion is created in particular by the introduction of a microphone-shaped speaker, which few in the audience is likely to expect. The local performer thus gets the chance to present a new and effective illusion. The emitted sounds, coupled with lip synching, present an extremely realistic performance to the audience since the vocal sounds or voice seem to be created directly where the local performer's mouth is located. The illusion and effect is accomplished by the use of the invention, a microphone-shaped speaker connected to a source of one or more professionally recorded or pre-recorded songs which play through and are transmitted by the speaker housed in a microphone-looking device, located at the local performer's mouth during use.

### SUMMARY OF THE INVENTION

The present invention relates to a microphone-shaped speaker device, preferably powered by batteries, which in its preferred embodiment can be connected to source of pre-recorded, professionally produced songs. In one embodiment, the device is inter-connected by a simple input-output wire, from an mp3-player or an i-pod® or other similar device. In another embodiment, the handle or head of the device physically contains the electronics of one or more sound vocals, on a sound chip, on an mp3-player, an i-pod® device, or a similar set of electronics. Use of the device causes the pre-recorded song(s) to be played preferably through the head of the device, which is actually an output speaker, albeit the device looks like a microphone. Therefore it will not be easy for the user's audience to know or discern beforehand, that the user is just lip-synching. The invention is intended to overcome the above-described flaws of normal karaoke or lip synching where the input microphone is connected to a remote (remote, in this context, means, away from the performer's mouth) speaker or a piece of common audio equipment. It is an object of the invention to enable the user to effectively imitate a professional singer of a pre-recorded song by miming sounds or voice (lip synching) without the audience necessarily knowing that the sound or voice is originated by an electronic pre-recorded audio device. The sound seems to come from the local or amateur singer's mouth as the microphone-shaped speaker is really an audio signal output device. Holding it close to the lip synching performer allows him/her to mouth the words while the professional, pre-recorded song is played to the audience. The effect is convincing since the voice/sound seems to come from the local performer's mouth. The invention provides true benefits in terms of realism, illusion, fun and entertainment for user and audience.

### BRIEF DESCRIPTION OF THE DRAWINGS

FIG. 1 is an exploded, perspective view of the invention, connected to a pre-recorded audio signal providing device, like an i-pod®, connected by an input and output wire and a pair of RCA-type, female, mini-jacks.

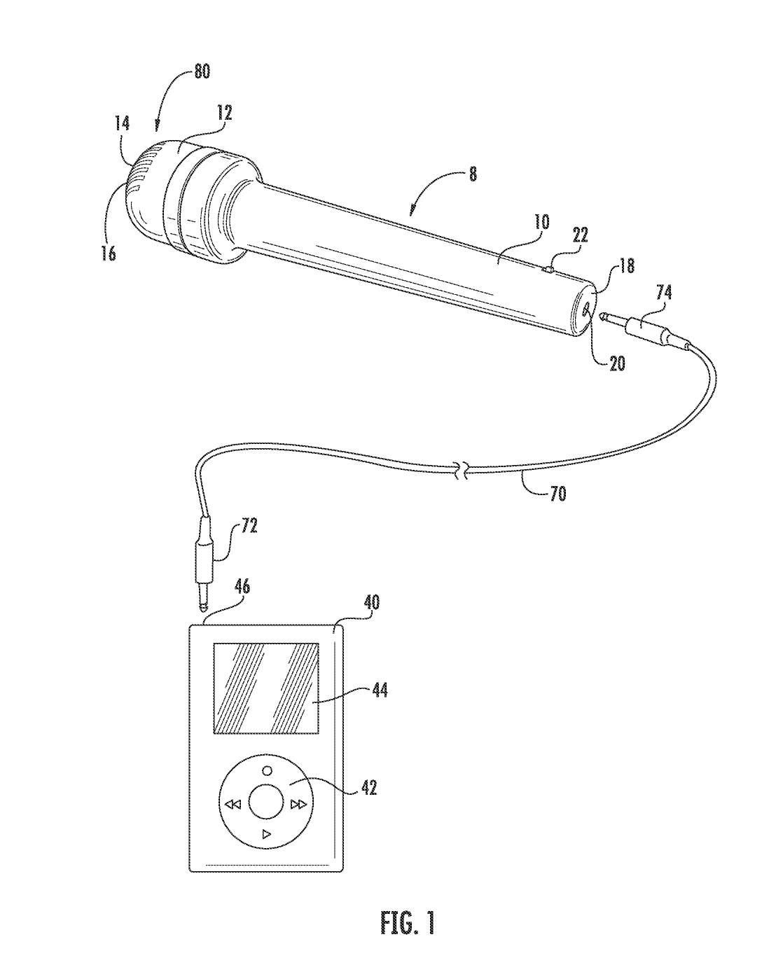

### DETAILED DESCRIPTION OF THE DRAWINGS AND THE PREFERRED EMBODIMENT

As best seen in the drawings, the invention in the preferred embodiment is a microphone-shaped speaker 8 consisting of a handle 10 and a head 12. The handle 10 is preferably cylindrical with a length of about 5 to 8 inches (easy to hold in a hand) and a slightly tapered cylindrical diameter of approximately 1 to 2 inches. The head 12 is a larger cylindrical section (in comparison to the handle 10) and preferably has a front end 14 which is either semi-spherical, rounded or even a block or other geometrical shape. The front end 14 can preferably be provided with a foam head (like conventional microphones) or can have a hard plastic dome-head (as shown in the Figure) with a set of slots 16 for permitting sound to emanate therefrom. The slots 16 look (to the audience) to be quite conventional as they are often provided on a microphone for allowing sound waves to pass therethrough into the receiver device of the microphone for the purpose of then transmitting sound into electrical signal for downline transmission to an amplifier. However, according to the invention, the slots 16 (of the preferred embodiment) allow, at least, the sound generated by a music producing device, whether an i-pod®-like player 40, an MP-3 player, a computer or even a sound chip (with or without controls) the latter housed within the handle 10, to play through and out of the device, at the head end 12 of the device 8.

Overall, the handle 10 and head 12 are intended to visually resemble and provide the appearance of an entertainment microphone. The front end 14 is generally cylindrical with a dome or semi-spherical roundness usually of a diameter of 2 to 5 inches. The front end 14 does not, however, need to contain the electro-mechanical elements or electronics for picking up and transmitting audio signal (voice) to an amplifier (although inclusion of the same and having the same device serve multiple purposes i.e., as a microphone and a speaker is within the scope of the present invention) but, necessarily, according to the invention, includes a speaker 80 (located just behind the slots 16 and within the hollow head 12 of the device. Preferably the speaker 80 and its output is located within the head 12 or front end 14 of the device 8 although the speaker 80 and its output could be located in the handle or even at the rear end or base 16.

The handle 10 is preferably plastic or metal and substantially hollow to hold batteries, if needed, to power the speaker of the device. It can also house other electronics necessary to drive the device so that when audio signals are provided to it, either in digital or analog form, they will be played to the audience through and out of the speaker 80 of the device 8. In an alternative embodiment, the handle 10 is provided with a self-contained i-pod®-like or MP-3 device with controls—volume, play, pause, advance, return, on-off, etc., i.e., finger sensitive button(s), passing through the side wall of the handle for use by the entertainer.

According to the current preferred embodiment of the invention, however, the device 8 can be used and sold as an associated piece of equipment with an i-pod® music or MP-3 player. In this connection, shown in the drawings, is a representative device 40, with well-known controls and a viewing screen, 42 and 44, respectively. A mini, female, RCA-type, audio output jack 44, normally for use by a set of headphones or an external speaker (not shown) is generally provided to the top of the device 40. That output jack serves to allow the digital signal to be played to a set of headphones or a speaker and is generally connected thereto by a male plug secured to the headphones or the external speaker.

According to the present invention, a connecting wire 70 connects the digital and audio signal of the device 40 to the invention, the microphone-shaped speaker 8. The connecting wire 70 can be of suitable length but should allow the signal playing device 40 to be hidden in a purse, pocket or jacket while the local entertainer/user holds the microphone-shaped device 8 in his/her hand. The connecting wire 70 is provided with a first RCA-type, mini, male plug or jack 72 for selective insertion and holding (until selective removal) into the correspondingly shaped and sized female jack 44 of the audio signal playing device 40. The other end of the connecting wire 70 is provided with another RCA-type, mini, male plug or jack 74. It is selectively connected into the input (a female, mini, RCA-type jack) 20 of the device 8, preferably at the rear wall or end 16 of the handle 10. Of course, the internal wiring of the device allows the digital or analog signal output of the music-sound playing device (in this case an i-pod® player 40) to be played from it, through its output jack 44, into the input jack 72 of connecting wire 70, through the wire of the connecting wire, out the output jack 74, and into the female jack 20 of the device 8. From there, the digital or audio signal is transmitted, by well-known electrical wiring or electronics, through the device and into a speaker 80, otherwise conventional, which is preferably located just beneath the slots 16 of the head end 12. There, while lip synching, the audio signals emanate into the audience with the intended illusion and effect that it appears that the voice of the person holding the microphone to his/her mouth is the professional singer of the song coming from the i-pod®. The effect is striking and very convincing, to the delight of the local entertainer and the audience.

The microphone-shaped speaker or device 8 and certainly the speaker 80 is preferably powered by batteries, and, therefore, the handle is likely fully hollow and contains a battery compartment and door (for battery replacement) for one or more electric-power driving batteries. The power to the speaker can be switched on/off by using the small toggle switch 22 which passes through the outside surface of the handle 10 for finger control by the user. With respect to cost of manufacture it has been found that plastic is preferable to metal casing but either may be used. However from the point of durability metal is preferred and in keeping with the overall intended illusion, a highly finished, black or silver matte or shiny finished casing is preferred.

In an alternate embodiment of the invention, the music playing device 40, the technology similar to the i-pod® music player, MP3, is an integrated circuit with one or more songs pre-recorded thereon. That circuitry can be housed within the handle 10. Suitable controls, like buttons or the control pad 42 of the i-pod® device can be used and curved to the curvature of the handle. In this case, the viewing screen 44 can be curved, too, to conform to the curvature of the handle or it can be eliminated. At least one song needs to be pre-recorded and playable through and out of the speaker 80 of the device 8. If only a few songs are pre-recorded and stored onto an IC located within the handle of the device 8, then the exterior controls and a viewing screen may be eliminated, to obvious savings in cost of manufacture. The alternate embodiment also features a battery compartment for receipt, along with appropriate terminals and wiring, of one or more batteries. The same toggle on-off switch 22 can be provided for activating and turning off the device.

Alternatively, a computer, pda-device, i-pod® music player, mp-3 player, or similar device with either Bluetooth® or other wireless technology can transmit a pre-recorded song from the device to the microphone-simulating device. There, a receiver will receive the audio signals and play the same through the speaker of the device.

In use, the device 8 is held by the local entertainer's hand. That person is likely an amateur and is desirous of lip-synching to a pre-recorded song maintained on a source of one or more of such songs (for example, an i-pod® music player, an MP-3 player, a computer, etc. On one end, jack 72 of the connecting wire 70 is secured into the source of pre-recorded songs, device 40, having lyrics (and often accompanying music) and the other end of the connecting wire 70, via jack 74 is secured to the audio jack or inlet 20 of the microphone-shaped device 8. Then, the device 8 is turned, “on” by switching the toggle switch 22 to the “on” position, thereby putting the battery power (within the hollow handle 10) into electrical circuit communication with the speaker 80, at the head end 12 of the device 8. Then, when the song is “cued up” and played by the device 40, the audio signal is played out of its output jack 44. The signal is then picked up by jack 72, transmitted through connecting wire 70 and into the device 8 via jack 74, held in receptacle 20. The audio signal is then played out through the speaker 80. When the microphone-shaped device 8 is held by a local entertainer's hand, near to his/her mouth and the local entertainer lip-synchs to the well-known to him/her song, played by the device 40, the voice of the professional pre-recorded singer will be transmitted to an audience as if the local singer were actually singing the lyrics. The effect is quite convincing, primarily because the speaker is located within a device which is normally associated with entertainment and the audience is taken somewhat “off guard” not realizing that a speaker is within the microphone shaped device, as a replacement for the normally-present pick-up device of a microphone. When the song(s) are finished and the “performance” concluded, the on-off switch 22 and the device 40 can be switched off.

While the present invention has been described with a preferred embodiment and an alternate embodiment, other variations of the invention will be apparent to those of ordinary skill in the art without departing from the scope of the invention that is set forth in the appended claims.

I claim:

1. A device for providing the illusion that a lip-synching person has the voice of a pre-recorded singer comprising:
a microphone-shaped handle and head end, also comprising a rear end,
at least one of said handle, said head end or said rear end substantially concealing an audio speaker,
said audio speaker being electrically powered by a source of power and connectable to a source of one or more pre-recorded songs.

2. A device as claimed in claim 1 wherein said source of power is one or more batteries contained within said handle.

3. A device as claimed in claim 1 wherein said head end is provided with a foam head cap.

4. A device as claimed in claim 1 wherein said head end is provided with one or more slots for allowing the sound generated by said speaker to emanate therethrough.

5. A device as claimed in claim 1 wherein said head end is substantially semi-spherically shaped.

6. A device as claimed in claim 1 wherein said handle is cylindrical and slightly tapered from near said head end to said rear end.

7. A device as claimed in claim 1 wherein an input, female receiving mini jack for a connecting wire to said source of pre-recorded song(s) is located in said rear end of said handle.

8. A device as claimed in claim 1 wherein said handle is provided with an on-off switch for said electrical power.

9. A device as claimed in claim 1 wherein said handle is made from plastic.

10. A device as claimed in claim 1 further comprising a source of one or more pre-recorded songs

11. A device as claimed in claim 10 wherein said source of one or more pre-recorded songs is located in said handle.

12. A device as claimed in claim 10 wherein said source of one or more pre-recorded songs is a digital, audio signal provider.

13. A device as claimed in claim 11 wherein one or more controls of said source of one or more pre-recorded songs is located on said handle.

14. A device as claimed in claim 10 wherein said source of one or more pre-recorded songs is electrically connected to said audio speaker by a connecting wire.

15. A device as claimed in claim 14 wherein said connecting wire is provided with a pair of audio, male, mini-jacks.

16. A device as claimed in claim 15 wherein said handle is provided with an audio inlet in the form of a female, mini-jack for receipt of one of said audio, male, mini-jacks.

17. A device as claimed in claim 14 wherein said connecting wire comprises one or more mini-audio jacks.

18. A device as claimed in claim 1 wherein said pre-recorded song(s) are wirelessly connected to said speaker.

19. A method of realistically simulating singing by a local performer with the voice of a pre-recorded singer comprising the steps of:
a) pre-recording the audio signals of at least one song by a recorded singer onto electronic circuitry;
b) playing said audio signals of said pre-recorded song and having said signals emanate from a speaker;
c) having said local singer lip-synch to said audio signals emanating from said speaker; and
c) having said speaker housed in a realistic-looking, microphone-like device, located near to said local singer's mouth.

20. A method as claimed in claim 19 wherein said microphone-like device is hand-held.

21. A method as claimed in claim 20 wherein electronic circuitry for connecting said song(s) to said speaker is housed in said microphone-like device.
